(19) United States
(12) Patent Application Publication
(10) Pub. No.: US 2022/0270092 A1
(43) Pub. Date: Aug. 25, 2022

(54) Artificial Intelligence-Driven Data Exchange Systems and Methods

(71) Applicant: Reach Enterprises, Inc., Sunnyvale, CA (US)

(72) Inventors: Michael A. Ribero, Palo Alto, CA (US); George E. Northup, Redwood City, CA (US); Steve Owens, Austin, TX (US); Robert B. Vance, JR., Issaquah, WA (US)

(21) Appl. No.: 17/677,823

(22) Filed: Feb. 22, 2022

Related U.S. Application Data
(60) Provisional application No. 63/153,725, filed on Feb. 25, 2021.

(51) Int. Cl. G06Q 20/40

(52) U.S. Cl. CPC G06Q 20/401

(57) ABSTRACT

Artificial intelligence-driven data exchange systems and methods are disclosed herein. A method can include verifying when a merchant or brand is a participating member in an exchange ecosystem and the merchant or brand in good standing, determining if a member has sufficient exchange currency in a member account to complete a transaction, determining if the member has linked a credit or debit card to their member account, and approving the transaction based on an exchange score for the member and the credit or debit card.

### CROSS REFERENCE TO RELATED APPLICATIONS

This application claims the benefit and priority of U.S. Application Ser. No. 63/153,725, filed on Feb. 25, 2021, which is hereby incorporated by reference herein including all references and appendices cited therein, for all purposes.

### FIELD

The present disclosure pertains to artificial intelligence-driven data exchange systems and methods.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes verifying when a merchant or brand is a participating member in an exchange ecosystem and the merchant or brand in good standing; determining if a member has sufficient exchange currency in a member account to complete a transaction, determining if the member has linked a credit or debit card to their member account, and approving the transaction based on an exchange score for the member and the credit or debit card. Other embodiments of this aspect include corresponding computer systems, apparatus, and computer programs recorded on one or more computer storage devices, each configured to perform the actions of the methods.

Implementations may include one or more of the following features. The method may include issuing the merchant or brand an amount of the exchange currency based on a payment in fiat currency. The method may include: receiving from the merchant or brand information indicative of a behavior that, when performed, merits exchange currency. A portion of the transaction is satisfied using the exchange currency; and transferring a portion of the exchange currency to the member from the merchant or brand. A remaining portion of the transaction is satisfied with the credit or debit card. The method may include allowing the merchant or brand to select how much of the exchange currency is to be provided to the member based on the behavior. The method may include assigning to the member an exchange card that may include the exchange currency, the exchange currency being configured for use with a merchant or brand point of sale, the exchange currency being used in a manner that is identical to fiat currency. The method may include providing the merchant or brand with the fiat currency when the member uses the exchange card at the point of sale and utilizes the exchange currency for the transaction. The member is never provided with the fiat currency when the item is returned unless a portion of the transaction was paid for with the fiat currency. The value is based on any of a history or tenure of the member within the exchange, an analysis of activities of the member within the exchange, an amount of data about the member that is shared within the exchange, a number of merchants on the exchange that the member has engaged with, an influence of the member, or combinations thereof. The method may include allowing the member to complete the transaction when the member does not have sufficient exchange currency and the credit or debit card has insufficient funds. Implementations of the described techniques may include hardware, a method or process, or computer software on a computer-accessible medium.

One general aspect includes a system having a processor; and a memory for storing instructions, the processor executing instructions stored in memory to: verify when a merchant or brand is a participating member in an exchange ecosystem and the merchant or brand in good standing; determine if a member has sufficient exchange currency in a member account to complete a transaction; determine if the member has linked a credit or debit card to their member account; and approve the transaction based on an exchange score for the member and the credit or debit card. Other embodiments of this aspect include corresponding computer systems, apparatus, and computer programs recorded on one or more computer storage devices, each configured to perform the actions of the methods.

Implementations may include one or more of the following features. The system where the processor is configured to issue the merchant or brand an amount of the exchange currency based on a payment in fiat currency; and receive from the merchant or brand information indicative of a behavior that, when performed, merits exchange currency. The processor is configured to: determine that the member has approved sharing of member data with the merchant or brand; determine that the member has engaged in the behavior, where a portion of the transaction is satisfied using the exchange currency; and transfer a portion of the exchange currency to the member from the merchant or brand. The processor is configured to perform a split transaction when the exchange currency is insufficient to complete the transaction, where a remaining portion of the transaction is satisfied with the credit or debit card.

The processor is configured to allow the merchant or brand to select how much of the exchange currency is to be provided to the member based on the behavior. The processor is configured to assign to the member an exchange card that may include the exchange currency, the exchange currency being configured for use with a merchant or brand point of sale, the exchange currency being used in a manner that is identical to fiat currency, where the merchant or brand point of sale is in communication with the system.

The processor is configured to provide the merchant or brand with the fiat currency when the member uses the exchange card at the point of sale and utilizes the exchange currency for the transaction. The processor is configured to: determine that the member is returning an item which was part of the transaction; and return to the member the exchange currency for the item, where the member is never provided with the fiat currency when the item is returned unless a portion of the transaction was paid for with the fiat currency.

The processor is configured to calculate the exchange score for the member, which is indicative of a value of the member to the exchange and/or the merchant or brand, where the value is based on any of a history or tenure of the member within the exchange, an analysis of activities of the member within the exchange, an amount of data about the member that is shared within the exchange, a number of merchants on the exchange that the member has engaged with, an influence of the member, or combinations thereof. Implementations of the described techniques may include hardware, a method or process, or computer software on a computer-accessible medium.

### BRIEF DESCRIPTION OF THE DRAWINGS

Exemplary embodiments are illustrated by way of example and not limitation in the figures of the accompanying drawings, in which like references indicate similar elements.

FIG. 1 is a schematic diagram of an example architecture where aspects of the present disclosure can be practiced.

FIG. 2 is a flowchart of an example method of the present disclosure.

FIG. 3 is a flowchart of an example method of the present disclosure.

FIG. 4 is a flowchart of a further example method of the present disclosure.

FIG. 5 is a simplified block diagram of a computing system, in accordance with some embodiments.

### DETAILED DESCRIPTION OF EXAMPLE EMBODIMENTS

### Example Embodiments

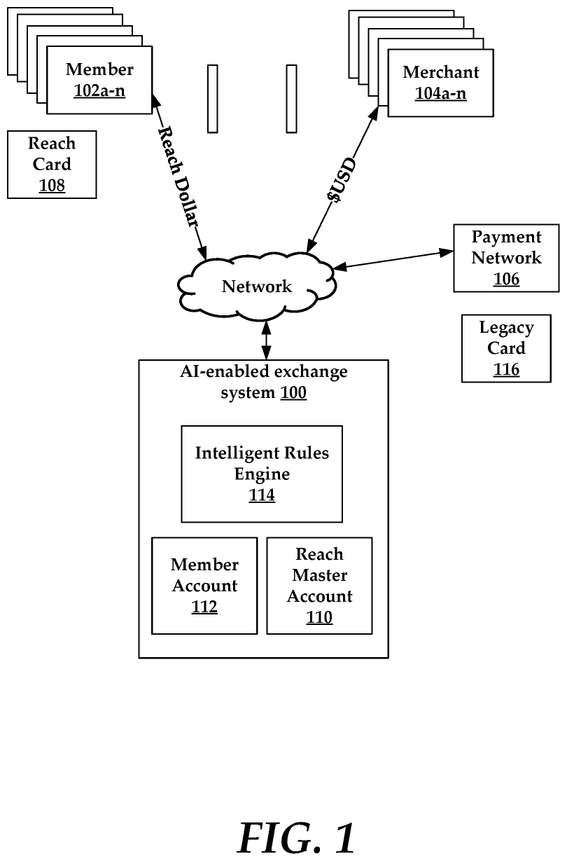

FIG. 1 illustrates an example architecture that can be used to implement embodiments of the present disclosure. The present disclosure pertains to systems and methods that leverage artificial intelligence and machine learning to provide a real-time or near real-time marketplace where members and merchants can engage the exchange of information for value.

In some embodiments, the architecture can include an AI-enabled exchange system (hereinafter “system 100”) that enables members to use loyalty currency, referred to herein as “exchange currency”, just like a fiat currency (such as $USD) to purchase anything offered by a merchant (e.g., brand) within the architecture. For example, the architecture can include a plurality of members 102a-n, where each member can commercially interact with and conduct business with one or more of a plurality of merchants 104a-n. A member can specific which of the merchants 104a-n they want to share their information with, allowing a member to create a Brand Circle comprised of two or more of the merchants 104a-n. The benefits and advantages of allowing members to select who their data is shared with will be discussed in greater detail herein.

The system 100 allows members to purchase goods or services from merchants using an exchange currency, referred to herein as a “Reach Dollar”. Reach Dollars are distributed to members based on their engagement with the system 100 on a merchant-by-merchant basis. For example, Reach Dollars, which are earned by members based on the value they create for brands they approve. The Reach Dollars may be initially purchased by a merchant who wishes to engage a member in activities which grow recognition of the brand of the merchant. For example, the merchant can buy $1,000.00 of Reach Dollars in equivalent US currency. Reach Dollars are a proprietary currency within the system 100. The merchant can direct the system 100 distribute Reach Dollars to members who both (1) approve of sharing their member data with the merchant, and (2) engage in behaviors that merit Reach Dollars. In some instances, some member activities and/or behaviors have different “value” in terms of Reach Dollars. For example, writing a blog post may merit more Reach Dollars than liking a post of the merchant on a social media platform. In general, the Reach Dollars have functional attributes that are similar to loyalty programs. However, when a member purchases something from an approved merchant, the merchant receives remuneration from the system 100 in US currency.

When Reach Dollars are distributed to a member, these Reach Dollars can be accessed via a Reach Card assigned to the member. In one example, the Reach Card is a hybrid debit/credit card. Existing loyalty programs which allow members to use their proprietary currency for purchases at select merchants require significant modification to the merchant's point-of-sale (“POS”) system as well as the payment network itself. That is the reason these technologies are limited to financial institutions and credit card companies.

The system 100 is configured to not only expand beyond financial services, the system 100 can provide Reach Dollar loyalty program capabilities with no modification required to either an existing payment network 106 or any participating merchants' (or brands') POS systems. As a result, the system 100 enables members, each of which will receive a virtual Reach Card 108 (for example a Visa or Mastercard Card with no credit check required), to access their Reach Dollars and use them just like the underlying currency (such as United States Dollars) at any participating merchant (or brands) within the purview of the system 100. More specifically, the system 100 allows members (consumers) to access a proprietary/alternative currency in real-time and use it for payment as if it were $USD via a unique hybrid Reach Visa card that works like a debit card for purchases, using the existing Visa credit card network (or any comparable network, such as the existing payment network 106) and existing merchant/brand POS systems (merchants 104a-n) with no modifications to the current payment flow between the merchants 104a-n and the existing payment network 106.

The system 100 allows members to pay for purchases using a proprietary currency but with the merchant (or brand) receiving payment in $USD. This is achieved via technology that operates on a just-in-time basis. The system 100 treats the Reach Card 108 as a debit card for purchases by making a series of hierarchical decisions based on various parameters (including ensuring the member has sufficient Reach Dollars in their account), all on an automated basis, to determine if a transaction should be approved. If the transaction is approved, settlement is triggered from a Reach Master Account 110 in $USD.

Such a separation of transaction flow ensures that members cannot return items purchased with Reach Dollars for $USD, with the system treating the Reach Card 108 similarly to a credit card when it comes to merchandise returns. Hence, if a member attempts to return anything they purchased with their Reach Card using Reach Dollars, the system 100 will simply credit their card with the amount originally paid, with the system 100 redepositing the Reach Dollars back into a member account 112 and obtaining the actual $USD refund, which is deposited into the Reach Master Account 110.

This ensures that there is no way members can convert Reach Dollars into $USD, meaning Reach Dollars must be reinvested back into the ecosystem of brands that comprise the marketplace for the member to obtain value. The tightly-closed-loop functionalities enabled by the system 100 ensure that participating brands benefit incrementally from the compensation they provide members, as compensation is only provided for activity that is proven to add value to each participating brand.

As noted above, the system 100 operates on a just-in-time basis to maintain a member's balance in their member account 112 until the member proactively chooses to access their Reach Dollars for a purchase. This has a variety of economic benefits while ensuring participating brands are the beneficiaries of this member spending.

Correspondingly, approval processing must also take place in real-time, and given the nature of the system 100, the members 102a-n, and the proprietary currency, the approval process is more complex and hierarchical, something the technology can accommodate.

In some embodiments, the system 100 can implement an intelligent rules engine 114 to oversee approvals and transaction management and processing in real time. The intelligent rules engine 114 can be configured to determine whether a transaction would be paid with Reach Dollars, via a linked credit card, or a combination based on user preferences, even if the member has sufficient funds to complete the transaction with Reach Dollars only. The intelligent rules engine 114 can be configured to provide spontaneous rewards in real time based on analysis of consumer on geo-location, spending patterns or other information in the system, with that reward coming in the form of a discount that is completely transparent to the merchant (or brand) and could come as a surprise (unanticipated reward) to members. For example, a member can purchase food from a restaurant through a food delivery application. As a reward, the system 100 can automatically (through algorithmic planning or random selection) pay for a delivery service charge or taxes as an incentive to the member.

The intelligent rules engine 114 can provide targeted subsidies as part of a membership provision. For example, the system can recognize shipping fees and subsidize those for a member that has a premium membership that pays for all or a portion of the shipping costs when the member uses their Reach Card.

The intelligent rules engine 114 can implement artificial intelligence to make decisions and approve a member's transaction even if there are insufficient funds in the member account and they have no conventional credit or debit card linked to their account to facilitate a split purchase. The AI would be driven by a Reach Score for the member, which determines their value to the marketplace, and ultimately, each participating brand. A member's Reach Score may be determined by any combination of the following. One aspect includes a member's history or tenure, where their activity during that tenure comprises a key part of their Reach Score. Another aspect includes a member's profile. The more a member shares about themselves within the confines of the system 100, and the more personal information they share with the merchants/brands in their Brand Circle, the higher their Reach Score. This includes data appended from external sources (such as social media platforms e.g., LinkedIn, their Credit History, and so forth) and plug-ins implemented (search monitor via browser or viewing auditor via Smart Televisions or other similar devices). Another aspect can include a member's circle. To be sure, the more brands with which the member has engaged with over their tenure, the higher their Reach Score. One aspect includes member activities. As members engage in more activities, and the scope and value of each, their Reach Score can increase. A Reach Score can also increase based on a member's influence. Thus, the more influential the member, as determined by what they have created (communities, opportunities), benefitted (causes), and impacted (via social media as determined by the type of messaging and audience reached/followers).

Some embodiments of the system 100 enable Intelligent Marketing features and enhanced member navigation. Also, the system 100 enables compliance in an otherwise increased compliance environment where GDPR and CCPA and other regulations exist. This is true because members have complete control of the data they share with only their selected merchants. The system 100 allows for bundling a perpetual suite of personal information with full consumer permission to brands.

The member has control and authority over the scope of information shared and over the range of brands shared with and the nature of information shared by members with merchants is zero party data. The member receives Reach Dollar compensation from brands for the range of information provided and creating permissions.

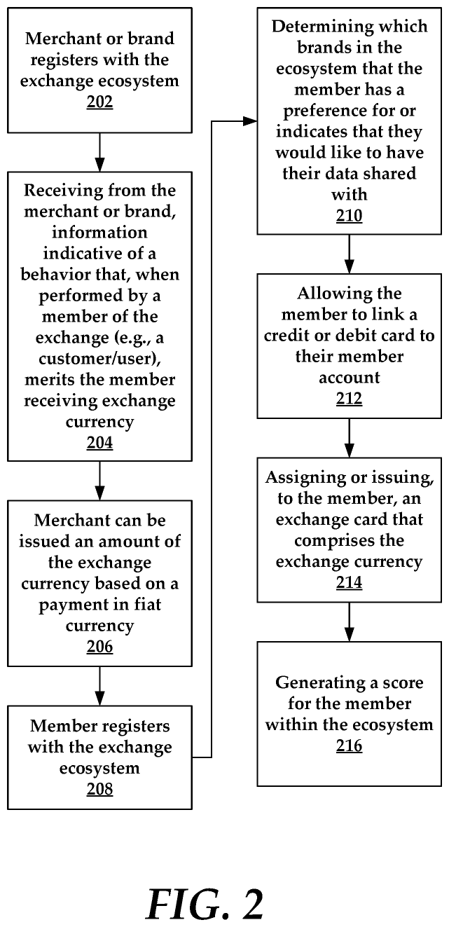

An example hierarchy implemented by the system 100 is illustrated in the flowchart of FIG. 2. In some embodiments, a method can include a step 202 of a merchant or brand registers with the exchange ecosystem. This can include a step 204 of receiving from the merchant or brand, information indicative of a behavior that, when performed by a member of the exchange (e.g., a customer/user), merits the member receiving exchange currency. In some embodiments, the merchant or brand can select how much of the exchange currency is to be provided to the member based on the behavior. These can be specified on a behavior-by-behavior basis, where some behaviors or actions are rewarded more generously than others.

A merchant or brand may wish for members to share or promote social medial content. In another example, the member could create a blog or become an affiliate marketer. There is no limit to the types of behavior that can merit exchange currency, or the value that the merchant ascribes to such behavior(s).

In step 206, the merchant can be issued an amount of the exchange currency based on a payment in fiat currency. For example, the merchant can buy a predetermined amount of exchange currency for 10,000.00 USD. The merchant can allow the exchange ecosystem to pay a member in exchange currency for behaviors and/or the performance of acts that are to be benefit of the brand.

In step 208, a member registers with the exchange ecosystem. This can include the member creating a membership profile which can specify their preferences and other demographic information. Part of the registration process can include a step 210 of determining which brands in the ecosystem that the member has a preference for or indicates that they would like to have their data shared with. For example, the ecosystem may have fifty brands as registered merchants. The member can select one or more of these brands to share their data with. In this way, the member controls their data. The member can specify, with granularity, what types or amounts of their data are shared with brands. In some embodiments, once an account/profile for the member has been created, the method can include an optional step 212 of allowing the member to link a credit or debit card to their member account.

The methods can include a step 214 of assigning or issuing, to the member, an exchange card that comprises the exchange currency. The exchange currency can be configured for use with a merchant or brand point of sale or for conducting transactions with the merchants in the exchange ecosystem in any known manner. The exchange currency can used in a manner that is identical to fiat currency.

As the member participates in the exchange ecosystem, the method can include a step 216 of generating a score for the member within the ecosystem. The score is indicative of a value of the member to the exchange and/or the merchant or brand, wherein the value is based on any of a history or tenure of the member within the exchange, an analysis of activities of the member within the exchange, an amount of data about the member that is shared within the exchange, a number of merchants on the exchange that the member has engaged with, an influence of the member, or combinations thereof.

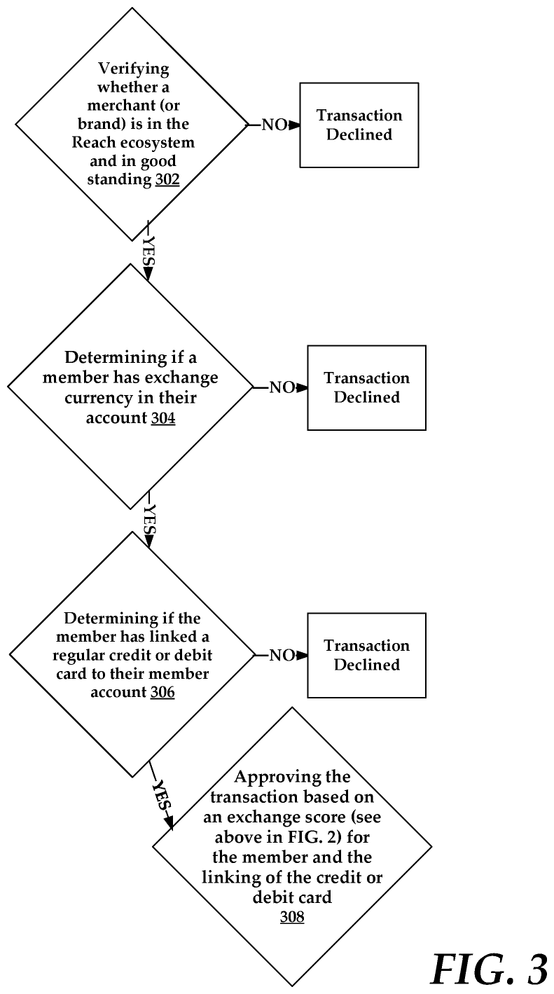

FIG. 3 is a flowchart that is related to FIG. 2, and can be performed after the steps set forth in FIG. 2. An example method can include a step 302 of verifying whether a merchant (or brand) is a participating member in the Reach ecosystem and in good standing [If yes, transaction proceeds; if no, transaction declined].

Next, the method can include a step 304 of determining if a member has exchange currency in their account [If yes, transaction approved; if no, transaction proceeds]. If the funds are insufficient, the method can include a step 306 of determining if the member has linked a regular credit or debit card to their member account (see member account 112 of FIG. 1), and if they have, ensuring the credit limit (credit card) or available funds (debit card) are sufficient to complete the transaction when combined with the members available Reach Dollars [If yes, transaction approved; if no, transaction declined].

If the transaction is approved using both Reach Dollars (via a member account) and their linked credit or debit card (e.g., Legacy Card 116), the method can include a step 308 of approving the transaction based on an exchange score (see above in FIG. 2) for the member and the linking of the credit or debit card. The transaction can be fulfilled with exchange currency, fiat currency from the linked credit or debit card.

In some instances, the transaction can be permitted when funds are insufficient based on a member's Reach Score. In some embodiments, split transaction capability using a loyalty or proprietary currency in tandem with $USD in a manner is completely transparent to the merchant (or brand), requiring no modification to their POS system.

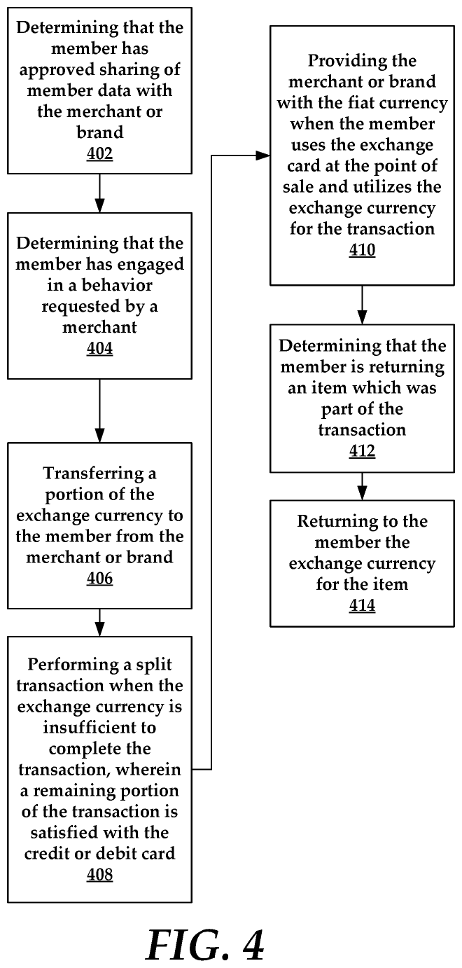

FIG. 4 is a flowchart of an example method. The method can include a step 402 of determining that the member has approved sharing of member data with the merchant or brand. The method can also include a step 404 of determining that the member has engaged in a behavior requested by a merchant. Next, the method can include a step 406 of transferring a portion of the exchange currency to the member from the merchant or brand. As noted above, a portion of the transaction can be satisfied using the exchange currency, but also with a linked credit/debit card, and/or based on the member's ecosystem reputation as indicated by their Reach Score. Thus, in some embodiments, the method can include a step 408 of performing a split transaction when the exchange currency is insufficient to complete the transaction, wherein a remaining portion of the transaction is satisfied with the credit or debit card.

The method can also include a step 410 of providing the merchant or brand with the fiat currency when the member uses the exchange card at the point of sale and utilizes the exchange currency for the transaction. Next the method includes a step 412 of determining that the member is returning an item which was part of the transaction, as well as a step 414 of returning to the member the exchange currency for the item. It will be understood that the member is never provided with the fiat currency when the item is returned unless a portion of the transaction was paid for with the fiat currency.

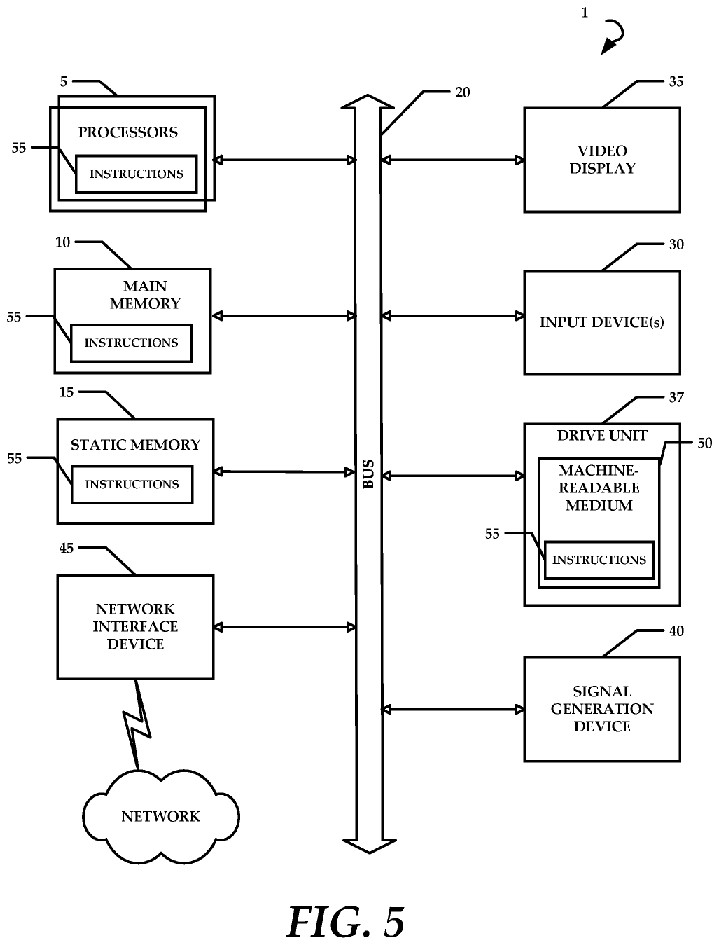

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

1. A method comprising:
verifying when a merchant or brand is a participating member in an exchange ecosystem and the merchant or brand in good standing;
determining if a member has exchange currency in a member account;
determining if the member has linked a credit or debit card to their member account; and
approving a transaction based on an exchange score for the member and the credit or debit card, using at least a portion of the exchange currency.

2. The method according to claim 1, further comprising issuing the merchant or brand an amount of the exchange currency based on a payment in fiat currency.

3. The method according to claim 1, further comprising: receiving from the merchant or brand information indicative of a behavior that, when performed, merits exchange currency.

4. The method according to claim 3, further comprising:
determining that the member has approved sharing of member data with the merchant or brand;
determining that the member has engaged in3, wherein a portion of the transaction is satisfied using the exchange currency; and
transferring a portion of the exchange currency to the member from the merchant or brand.

5. The method according to claim 4, further comprising performing a split transaction when the exchange currency is insufficient to complete the transaction, wherein a remaining portion of the transaction is satisfied with the credit or debit card.

6. The method according to claim 4, further comprising allowing the merchant or brand to select how much of the exchange currency is to be provided to the member based on the behavior.

7. The method according to claim 1, further comprising assigning to the member an exchange card that comprises the exchange currency, the exchange currency being configured for use with a merchant or brand point of sale, the exchange currency being used in a manner that is identical to fiat currency.

8. The method according to claim 7, further comprising providing the merchant or brand with the fiat currency when the member uses the exchange card at the point of sale and utilizes the exchange currency for the transaction.

9. The method according to claim 8, further comprising:
determining that the member is returning an item which was part of the transaction; and
returning to the member the exchange currency for the item, wherein the member is never provided with the fiat currency when the item is returned unless a portion of the transaction was paid for with the fiat currency.

10. The method according to claim 1, further comprising calculating the exchange score for the member, which is indicative of a value of the member to the exchange and/or the merchant or brand, wherein the value is based on any of a history or tenure of the member within the exchange, an analysis of activities of the member within the exchange, an amount of data about the member that is shared within the exchange, a number of merchants on the exchange that the member has engaged with, an influence of the member, or combinations thereof.

11. The method according to claim 10, further comprising allowing the member to complete the transaction when the member does not have sufficient exchange currency and the credit or debit card has insufficient funds.

12. A system comprising:
a processor; and
a memory for storing instructions, the processor executing instructions stored in memory to:
verify when a merchant or brand is a participating member in an exchange ecosystem and the merchant or brand in good standing;
determine if a member has sufficient exchange currency in a member account to complete a transaction;
determine if the member has linked a credit or debit card to their member account; and
approve the transaction based on an exchange score for the member and the credit or debit card.

13. The system according to claim 12, wherein the processor is configured to issue the merchant or brand an amount of the exchange currency based on a payment in fiat currency; and receive from the merchant or brand information indicative of a behavior that, when performed, merits exchange currency.

14. The system according to claim 12, wherein the processor is configured to:
determine that the member has approved sharing of member data with the merchant or brand;
determine that the member has engaged in the behavior, wherein a portion of the transaction is satisfied using the exchange currency; and
transfer a portion of the exchange currency to the member from the merchant or brand.

15. The system according to claim 14, wherein the processor is configured to perform a split transaction when the exchange currency is insufficient to complete the transaction, wherein a remaining portion of the transaction is satisfied with the credit or debit card.

16. The system according to claim 14, wherein the processor is configured to allow the merchant or brand to select how much of the exchange currency is to be provided to the member based on the behavior.

17. The system according to claim 12, wherein the processor is configured to assign to the member an exchange card that comprises the exchange currency, the exchange currency being configured for use with a merchant or brand point of sale, the exchange currency being used in a manner that is identical to fiat currency, wherein the merchant or brand point of sale is in communication with the system.

18. The system according to claim 17, wherein the processor is configured to provide the merchant or brand with the fiat currency when the member uses the exchange card at the point of sale and utilizes the exchange currency for the transaction.

19. The system according to claim 18, wherein the processor is configured to:
determine that the member is returning an item which was part of the transaction; and
return to the member the exchange currency for the item, wherein the member is never provided with the fiat currency when the item is returned unless a portion of the transaction was paid for with the fiat currency.

20. The system according to claim 12, wherein the processor is configured to calculate the exchange score for the member, which is indicative of a value of the member to the exchange and/or the merchant or brand, wherein the value is based on any of a history or tenure of the member within the exchange, an analysis of activities of the member within the exchange, an amount of data about the member that is shared within the exchange, a number of merchants on the exchange that the member has engaged with, an influence of the member, or combinations thereof.
